(19) United States
(12) Patent Application Publication
(10) Pub. No.: US 2012/0281533 A1
(43) Pub. Date: Nov. 8, 2012

(54) SYSTEMS AND METHODS FOR TIME OPTIMIZATION FOR SILENCING WIRELESS DEVICES IN COEXISTENCE NETWORKS

(75) Inventors: Ariton E. Xhafa, Plano, TX (US); Yanjun Sun, Richardson, TX (US); Ramanuja Vedantham, Allen, TX (US); Assaf Sella, Plano, TX (US); Josef Peery, Kadima, IL (US); Xiaolin Lu, Plano, TX (US)

(73) Assignee: TEXAS INSTRUMENTS INCORPORATED, Dallas, TX (US)

(21) Appl. No.: 13/463,263

(22) Filed: May 3, 2012

Related U.S. Application Data
(60) Provisional application No. 61/481,828, filed on May 3, 2011.

(51) Int. Cl. H04W 24/00; H04W 28/10

(52) U.S. Cl. 370/230; 370/252

(57) ABSTRACT

In at least some embodiments, a communication device includes a transceiver with at least two dissimilar wireless network technology subsystems. The communication device also includes a silencing frame controller to monitor access point rate drop behavior and to adjust a level of silencing frame operations for the communication device based on the monitored access point drop behavior.

### CROSS-REFERENCE TO RELATED APPLICATION

The present application claims priority to U.S. provisional patent application Ser. No. 61/481,828, filed May 3, 2011, and entitled “Rate Prediction For Adjusting Silencing Frames”, hereby incorporated in its entirety herein by reference.

### BACKGROUND

Next-generation mobile devices will be able to access a variety of network technologies including, for example, worldwide interoperability for microwave access (WiMAX) networks, wireless local area network (WLAN) networks, long term evolution (LTE) mobile telephony networks, personal area networks (PANs), wireless universal serial bus (USB) networks or BLUETOOTH® (BT) technology networks, etc. The various applications have different transmission timing requirements in order to provide a needed quality of service (QoS). Quality of service refers to mechanisms for controlling resource reservation rather than the achieved service quality. QoS is the ability to provide different priority to different applications, users, or data flows, or to guarantee a certain level of performance to a data flow, e.g., guarantee a required bit rate, delay, jitter, packet dropping probably, bit error rate, etc. Quality of service guarantees are important, for example, if the network capacity is insufficient or limited, especially for real-time streaming multimedia applications such as voice over IP, online games and IP-TV, since these delay sensitive applications often require a fixed bit rate.

The IEEE802.11 specification provides a quality of service control protocol that enables a service differentiation to be provided for packets. For example, voice and e-mail traffic require different quality of service levels to provide acceptable service quality. In particular, voice packets need to be delivered within strict delay bounds whereas e-mail packets are more delay tolerant.

While increased access to these technologies will benefit users and operators alike, interference among different technologies, particularly onboard a single device, introduces difficulties during concurrent operation of these technologies. For example, and as illustrated in FIG. 1, wireless local area network (“WLAN”; 2.4-2.5 GHz) and other technologies, such as Bluetooth (“BT”; 2.4-2.4835 GHz) and Worldwide Interoperability for Microwave Access (“WiMAX”; 2.3-2.4 GHz and 2.5-2.7 GHz), operate at relatively close and, in some cases, overlapping frequency bands with respect to each other—so close, in fact, that the out-of-band emission by either technology may saturate the receiver of the other technology resulting in potential blocking. Therefore, the interference between these two technologies operating in the same device creates challenges on the coexistence of the corresponding wireless interfaces of that device.

As a result, various solutions are needed to enable the competition for resources among the technologies onboard a single device to be less apparent and less inconvenient to users.

### BRIEF DESCRIPTION OF THE DRAWINGS

For a detailed description of exemplary embodiments of the invention, reference will be made to the accompanying drawings in which:

FIG. 1 illustrates different network technologies and their operating bands;

FIG. 2 illustrates an example wireless local area network (WLAN) with an access point and a plurality of wireless devices/stations in accordance with embodiments;

FIG. 3 illustrates an exemplary access point and/or wireless device in accordance with embodiments;

FIG. 4 illustrates an example of a communication device in accordance with embodiments;

FIG. 5 a timing diagram for operations of a communication device in accordance with embodiments;

FIG. 6 illustrates another example of a communication device in accordance with embodiments;

FIG. 7 illustrates a method in accordance with embodiments; and

FIG. 8 illustrates another method in accordance with embodiments.

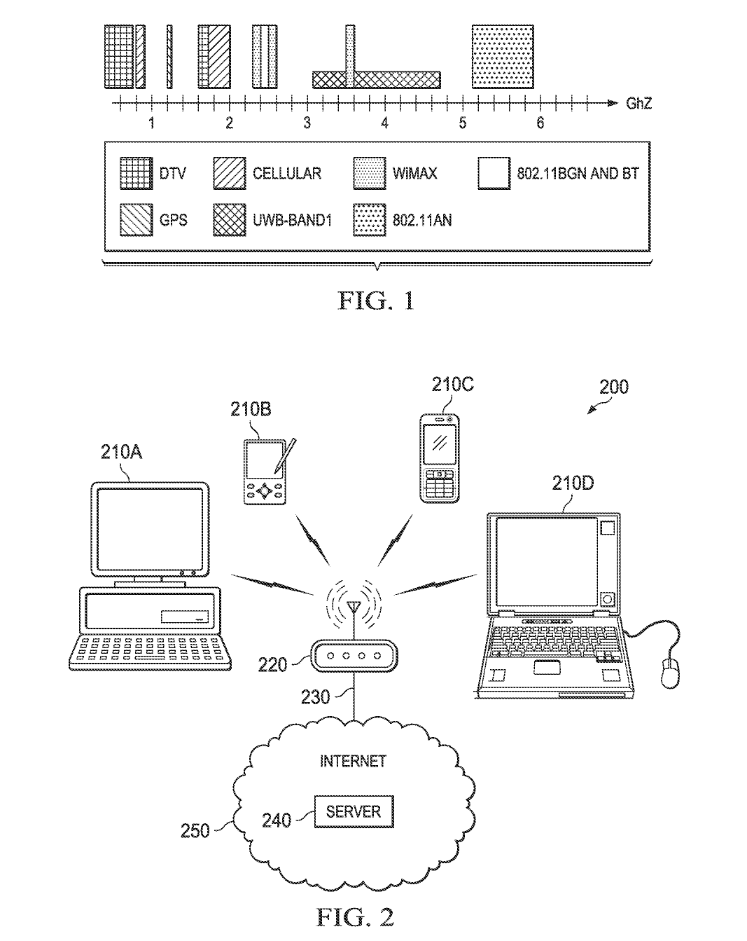

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

As disclosed herein, embodiments are directed to coexistence devices that implement a silencing frame (e.g., a clear-to-send-to-self or C2S-to-self frame) control scheme. In at least some embodiments, the silencing frame control scheme may involve monitoring the rate pullback behavior of an access point (i.e., a drop from a higher rate to a lower rate) and adjusting the timing or periodicity of silencing frame operation accordingly. Further, the silencing frame control scheme may involve monitoring the rate adaptation behavior of an access point (e.g., an increase from a lower rate to a higher rate) and adjusting the timing or periodicity of silencing frame operation accordingly. For example, the use of silencing frames by a coexistence device may increase in response an observed access point rate drop. Further, the use of silencing frames by a coexistence device may decrease in response to an observed access point rate increase. The silencing frame control scheme may additionally or alternatively rely on WLAN traffic monitoring, WLAN node detection, internal transmission detection, internal reception detection, or other criteria for a silencing frame control scheme as disclosed herein.

In working toward solving the coexistence problem, especially when wireless local area network (WLAN) technology is one of a plurality of network technology subsystems operating in a same device (i.e., onboard network technology subsystems), time-multiplexed operation among the onboard network technology subsystems is useful. For example, and not by way of limitation, in the case of WLAN and Bluetooth (BT) coexistence, BT voice calls may have priority over other traffic flows in a WLAN. As part of time-multiplexed operation in such exemplary device, during the time periods that the device operates in active BT mode, the WLAN services on the same device preferably operate in unscheduled automatic power saving delivery (U-APSD) mode. When the device switches to operate in active WLAN mode, the device sends a trigger frame (or a PS-Poll) to the access point (AP) indicating that the device is ready to act as a receiver, e.g., to receive packets of information. The AP may also be referred to herein as a transmitter, e.g., a transmitter of data packets. For the sake of discussion at this point, assume the transmitted packets of information—normally containing data—are correctly routed to the device as the intended recipient. Transmission becomes problematic if the packets addressed to the device are sent by the AP within the time period that the device is operating in active WLAN mode but the device has insufficient time to reply with an ACK (in case of immediate acknowledgment) because, for example, the device has switched back to active BT mode (e.g., incoming voice data) and misses the packet transmitted by the AP. In such case, no ACK would be sent by the device. As a further example, if the packets sent by the AP are not sent within the time interval that the device is operating in active WLAN mode, again no ACK would be sent by the device.

When the AP fails to receive an ACK from its intended recipient device, a transmission rate fallback mechanism commences at the AP. This mechanism reduces the transmission rate used to send subsequent packets from the AP to the device based on the failure to receive an ACK from the STA. In other words, when the AP transmits a packet to the intended device—also referred to herein as a station (STA)—and the AP receives no corresponding ACK from that device/STA, then the AP reduces the current transmission rate to a lower (slower) transmission rate because the AP assumes the communication channel between itself and the intended STA is bad.

Although the packet size does not change, as the transmission rate decreases, the total duration of the packet lengthens, which in turn results in an increased probability that the duration of the AP wireless transmission and the time the device is involved with a BT transmit/receive operation will time-wise overlap. Worse, as the packets transmitted over the channel medium occupy ever-lengthening intervals, the corresponding probability of a collision (time-wise overlapping) with the use by the device/STA of the medium on behalf of a different network technology subsystem (in the present example, in active BT mode), quickly increases. With the increased probability of collisions comes increased likelihood of the AP more often failing to receive an ACK, and in response continuing to lower the transmission rate (thereby increasing the duration of the transmission of the packet and, naturally, increasing the probability of a further collision such that the STA fails (again) to receive the packet, and fails (again) to send an ACK. It can be quickly appreciated that as this cycle proceeds, performance of the device STA rapidly deteriorates. This is unacceptable for many reasons, including violation of QoS (quality of service) requirements. Another reason stems from the practice of an AP to continue reducing the transmission rate until reaching a predetermined threshold, at which time the AP may unilaterally disconnect the device/STA from the network because the AP would not be able to transfer much if anything at all to the device beyond that threshold. The rapid deterioration in performance—and associated increase in probability of collision—is what will be referred to herein as an “avalanche effect” because, as time progresses, the message becomes buried and unrecoverable/lost. Simply, the avalanche effect reflects the phenomenon that the probability of losing a packet, and risk of potentially being unwillingly disconnected from the system, increases as the rate of transmission decreases.

To protect the network from the avalanche effect, embodiments employ a silencing frame. One example of a silencing frame, and not by way of limitation, would be a clear-to-send-to-self (CTS-to-self) frame. Thus, before the STA transitions to an active BT mode, the STA device sends the silencing frame and reserves the medium until the time corresponding to the end of the active BT mode or the end of that BT transmission ends—as the case may be—and the next lower priority network technology, e.g., WLAN, interval commences. However, it has become apparent that the use of silencing frames to protect priority interval transmissions from the avalanche effect in coexisting dissimilar technology subsystem networks drastically reduces the throughput of lower priority interval (e.g., WLAN, etc.) transmissions because devices/stations must defer (be silent) during the time set by the duration field corresponding to the network allocation vector (NAV) in the silencing frame. Thus, sending the silencing frame too early, results in other STAB/devices in the network—for example those on the WLAN—having to be quiet (deferring) for at least the entire BT active mode interval. This early deference, in turn, results in significantly decreased throughput of the network.

In light of the foregoing, embodiments are directed in general, to communication systems, and more specifically, to systems and methods of silencing wireless devices in coexistence networks to avoid triggering the AP transmission rate fall-back mechanism and still improve the performance of network resources. Embodiments provide systems and methods to optimize the time when to send silencing frames, and hence, improve the overall network throughput while avoiding avalanche effects.

To summarize, transmission of CTS-to-self frames reduces overall network performance since it silences all the nodes/stations in the network. Reducing the number of CTS-to-self frames to be transmitted can improve the performance of the network; however, this improvement can drastically reduce the performance of coexistence node. The reason is that while it allows other nodes/stations in the network to transmit (by not transmitting CTS-to-self frames), the transmission rate at the AP can drop drastically and making AP communication with coexistence node to always overlap with BT operation of coexistence node. Hence, it is important for the coexistence node to detect the rate drop behavior of the AP.

FIG. 2 illustrates an example wireless local area network (WLAN) 200 with a plurality of wireless devices/stations—referred to individually herein as device, station, STA or device/station—and an access point (AP), according to embodiments. It should be appreciated that the network of FIG. 2 is meant to be illustrative and not meant to be exhaustive; for example, it should be appreciated that more, different or fewer communication systems, devices and/or paths may be used to implement embodiments. To provide wireless data and/or communication services (e.g., telephone services, Internet services, data services, messaging services, instant messaging services, electronic mail (email) services, chat services, video services, audio services, gaming services, etc.), the exemplary WLAN 200 comprises access point (AP) 220 and any of a variety of fixed-location and/or mobile wireless devices or stations (STAB), four of which are respectively designated in FIG. 2 with reference numerals 210A, 210B, 210C and 210D. Exemplary devices 210 include any variety of personal computer (PC) 210A with wireless communication capabilities, a personal digital assistant (PDA) 210B, an MP3 player, a wireless telephone 210C (e.g., a cellular phone, a Voice over Internet Protocol (VoIP) telephonic functionality, a smart phone, etc.), and a laptop computer 210D with wireless communication capabilities, etc. At least one of AP 220 and STAB 210A-210D are preferably implemented in accordance with at least one wired and/or wireless communication standard (e.g., from the IEEE 802.11 family of standards). Further, at least one device 210 comprises a plurality of coexisting wireless network technology subsystems onboard the at least one device 210. In at least some embodiments, device 210 consists of a WLAN network and a BT network. The WLAN network may handle File Transfer Protocol (FTP), with internet file download, and e-mail traffic, while the BT network may handle synchronous connection-oriented high-quality voice level 3 (SCO HV3) traffic. At least one of STA 210A-210D corresponds to a WLAN and BT node, where transmissions in different networks are preferably achieved via a time-duplexing approach (ON/OFF). It will be noted that reference to “STA” (station) may be used herein as a shorthand reference communication devices 210 or 410 during respective discussions to aid in ease of understanding.

In the example of FIG. 2, to enable the plurality of devices/STAB 210A-D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver, for example, any variety of data, video, audio, telephone, gaming, Internet, messaging, electronic mail, etc. service. Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s). In accordance with embodiments, at least one of the STAB 210A-210D implement the silencing frame control scheme described herein.

To summarize, the wireless local area network (WLAN) 200 corresponds to a system with a communication device (e.g., STAs 210A-210D) with coexisting dissimilar wireless network technology subsystems, and an access point 220 in communication with the communication device. The communication device employs silencing frame transmission control rules to dynamically adjust a level of silencing frame operations based on a detected rate drop behavior of the access point 220. Further, the silencing frame transmission control rules may cause the communication device to dynamically adjust the level of silencing frame operations based on distinguishing between rate pullback operations of the access point and rate adaptation operations of the access point. Further, the silencing frame transmission control rules may cause the communication device to dynamically adjust the level of silencing frame operations based on monitoring a transmit link and a receive link of the communication device.

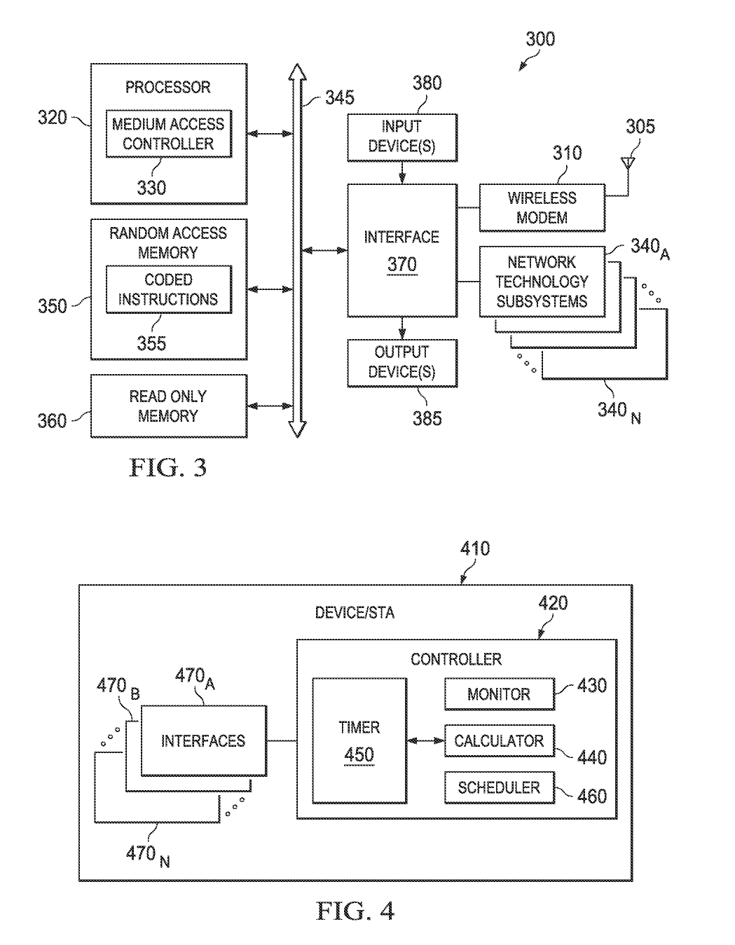

The disclosed silencing frame control scheme may be implemented on any general-purpose computer with sufficient processing power, memory resources, and network throughput capability to handle the necessary workload placed upon it. FIG. 3 illustrates an exemplary, general-purpose computer system suitable for implementing the silencing frame control scheme disclosed herein. The example device 300 of FIG. 3 may be an AP, STA or communication device, according to embodiments. It should be expressly understood that any device on, for example, WLAN 200 or other embodiments, may at times be an AP and at other times be a station. It should also be understood that in some embodiments, there may be at least one dedicated access point, with any number of devices acting as stations.

Exemplary device 300 comprises at least one of any of a variety of radio frequency (RF) antennas 305 and any of a variety of wireless modems 310 that support wireless signals, wireless protocols and/or wireless communications (e.g., according to IEEE 802.11n). RF antenna 305 and wireless modem 310 are able to receive, demodulate and decode WLAN signals transmitted to and/or within a wireless network. Likewise, wireless modem 310 and RF antenna 305 are able to encode, modulate and transmit wireless signals from device 300 to and/or within a wireless network. Thus, RF antenna 305 and wireless modem 310 collectively implement the “physical layer” (PHY) for device 300. It should be appreciated that device 300 is communicatively coupled to at least one other device and/or network (e.g., a local area network (LAN), the Internet 250, etc.). It should further be understood that illustrated antenna 305 represents one or more antennas, while the illustrated wireless modem 310 represents one or more wireless modems.

The exemplary device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by DRAM, SDRAM, and/or any other type of RAM device; ROM 360 may be implemented by flash memory and/or any other type of memory device.

Processor 320 implements MAC 330 using one or more of any of a variety of software, firmware, processing thread(s) and/or subroutine(s). MAC 330 provides medium access controller (MAC) functionality and further implements, executes and/or carries out functionality to facilitate, direct and/or cooperate in avoiding avalanche effect. MAC 330 is implemented by executing one or more of a variety of software, firmware, processing thread(s) and/or subroutine(s) with the example processor 320; further, MAC 330 may be, additionally or alternatively, implemented by hardware, software, firmware or a combination thereof, including using an application specific integrated circuit (ASIC), a programmable logic device (PLD), a field programmable logic device (FPLD), discrete logic, etc. In at least some embodiments, the silencing frame control scheme is implemented by the MAC 330.

Device 300 also preferably comprises at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

Interface 370, additionally or alternatively, communicatively couples wireless modem 310 with processor 320 and/or MAC 330. Interface 370 enables interface to, for example and not by way of limitation, Ethernet cards, universal serial bus (USB), token ring cards, fiber distributed data interface (FDDI) cards, network interface cards, wireless local area network (WLAN) cards, etc. to enable device 300 to communicate with other devices and/or communicate via Internet 250 or at least one intranet. With such a network connection, it is contemplated that processor(s) 320 would be able to receive information from at least one type of network technology, and/or output information to at least one type of network technology in the course of performing the herein-described processes. It should be appreciated that interface 370 implements at least one of a variety of interfaces, such as an external memory interface, serial port, communication internal to device 300, general purpose input/output, etc.

Device 300 further comprises at least two dissimilar network technology subsystems 340; as a result, device 300 is said to have coexisting network technology. “Dissimilar” is used in this context to mean that at least one of the subsystems 340 is from a different network technology than another one of the subsystems 340. It should be understood that some embodiments of subsystems 340 may have their own dedicated wireless modem and antenna, while other embodiments may share either or both of a wireless modem and antenna. Embodiments of device 300 comprise at least two wireless network technology subsystems 340. FIG. 3 illustrates network technology subsystems 340_{A}-340_{N}, where N=the number network technology subsystems in device 300. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc. Processor 320 interacts with network technology subsystems 340 via corresponding interfaces 470_{A}-470_{N} (see FIG. 4) implemented by interface 370. It should be appreciated that, for the ease of illustration, only two or three such network technologies may be discussed in connection with any particular embodiment, that more or fewer such technologies may be onboard a device, and that the present teachings apply equally thereto.

Before proceeding further, it should be understood that, for ease of understanding, embodiments will mostly be described herein in connection with a single lower priority technology network and a single higher priority technology network. However, embodiments should in no way be considered limited to just these two onboard technology network subsystems. In some embodiments, there may be additional and/or different onboard technology network subsystems. In some embodiments, there may be at least one lower priority technology network (e.g., WLAN, etc.) and a plurality of higher priority technology networks (e.g., BT, WiMAX, etc.). It should be appreciated that the scope of the present invention is not intended to be constrained to a single lower priority technology network and a single higher priority technology network onboard a device.

As illustrated in FIG. 4, an example communication device 410 comprises a controller 420 to implement the silencing frame control scheme described herein. The communication device 410 also comprises interfaces 470_{A}-470_{N}, where N=the number of onboard network technologies corresponding to each of the respective dedicated interfaces. The controller 420, in turn, comprises monitor 430, calculator 440, timer 450 and scheduler 460. It should be appreciated that although the example device of FIG. 4 illustrates a controller 420 as comprising, the monitor 430, the calculator 440, and the scheduler 460, that one or more of these elements may be external to controller 420. Moreover, it should also be appreciated that, in many embodiments, the controller 420 also comprises additional functionality such as security inputs (often from a user), managing power saving features for the interfaces, etc. In some embodiments, the communication device 410 comprises wireless links that may interfere with each other. For example, it may not be possible for two links to be active at the same time because the transmission of one interferes with the transmission of the other. Preferably time-division multiplexing is used where interfering links operate at different times, but embodiments of the scheduler 460 may account for the priority and parameters of each onboard network technology, as well as any negotiated parameters established during initial association with an AP.

In operation, the scheduler 460 may schedule the duration of each active network traffic flow in accordance with available the resources of the communication device 410. There are a variety of scheduling options, one of which may be fair allocation. Generally, the device alternates among the various active traffic flows—corresponding to each of the initiated network technology subsystems represented on device 410—depending upon each service/traffic flow's priority as determined by scheduler 460. Each network preferably takes sequential turns in using device 410's resources to send packets to—or otherwise communicate with—networks outside of device 410. Often, the scheduler 460 will establish a periodic transmission time for each onboard technology network subsystem, for improved and efficient use of device 410's resources. The periodic transmission(s) may also be provided to the AP(s) within any particular network to enable network-specific transmissions by the AP(s) during known network-specific active modes (reception) intervals. The scheduler 460 also may operate to transmit silencing frames according to the silencing frame control scheme disclosed herein. In at least some embodiments, silencing frames are transmitting during the period of Δt until the start of higher priority active mode interval—in accordance with a silencing frame control scheme trigger—otherwise, no silencing frame is to be transmitted. Once the higher priority active mode interval has ended, and a lower priority active mode has begun, scheduler 460 may again attempt to transmit a silencing frame during the period of Δt—as determined by calculator 440 and a silencing frame control scheme trigger—until start of higher priority active mode interval. As before, if the silencing frame cannot be transmitted prior to the start of the next immediate interval for higher priority active mode, no further effort is made to transmit a silencing frame. This process may repeat so long as higher priority active mode intervals continue to be scheduled and a silencing frame control scheme trigger exists.

In some embodiments, the monitor 430 operates to monitor traffic flow. For example, the monitor 430 may monitor the existence of active traffic flows onboard the device 410 and well as monitor what network technology (e.g., WLAN, BT, WiMAX, etc.) and what type of transmission (e-mail, streaming video, VoIP, etc.) is active. It should be appreciated that embodiments involve traffic flows regardless of type of traffic or whether the traffic is unicast, broadcast, multicast, etc.

Additionally, in at least some embodiments, controller 420 employs monitor 430 to track changes in the active traffic flows. If monitor 430 determines that there has been a change in at least one of the active traffic flows, it also identifies the change. As one example, and not by way of limitation, a WLAN MAC sends a trigger to controller 420 indicating that it wants to add traffic, i.e., initiate a traffic flow. Embodiments of scheduler 460 dynamically focus on scheduling and prioritizing among the service calls (requests) based on the information gathered by monitor 430. Among other monitoring operations, the monitor 430 may operate to monitor the pull back rate behavior and/or the rate adaptation behavior of an access point. The monitor 430 also may additionally or alternatively monitor WLAN traffic, WLAN node activity, internal transmission detection, internal reception detection, or other criteria as part of a silencing frame control scheme.

Embodiments of calculator 440 perform various calculating functions, including, but not necessarily limited to, determining Δt to be used by scheduler 460. Calculator 440 employs timer 450, as well as registers, to establish the transit time(s) between AP and STA (e.g., communication device 410 in the FIG. 4). At least some embodiments of calculator 440 calculate the Δt time interval as follows:

Δt=max_{—}i(AP_to_{—}STA1_{—}Tx_Time+STA1_to_{—}AP_{—}Tx_Time),
where “i” is the traffic flow indication from the AP to the STA and the latest duration values for each traffic flow duration are used to select the maximum value.

It should be appreciated that the time taken to transmit a silencing frame (e.g., a CTS-to-self frame) and, in some embodiments, a trigger frame (e.g., a trigger frame-ACK) from STA to the AP can be calculated because the STA device is the one initiating the transmission. Moreover, the time that the AP takes to transmit to the STA device can also be estimated from earlier transmissions, or may be a negotiated maximum transmitted size from the AP to STA in view of their negotiated data rates upon initial association. It should be appreciated that if the time the AP takes to transmit to the STA device is estimated from previous transmissions, it is preferred that the data rate and packet size from the most recent received transmission should be selected as the parameters from which to determine the AP to STA transmission time. Moreover, if there are multiple active traffic flows from AP to STA (e.g., belonging to different categories that may have different data rates and different packet sizes), because the STA will not know what the AP will send in response to the STA device's silencing frame, at least some embodiments of STA device preferably choose the maximum transmission time (data rate×packet size) among the transmission times most recently received with respect to each of the multiple active traffic flows. It should be appreciated that in some embodiments, the maximum duration among the earlier transmissions could be selected, although this selection tends to minimize the benefits of the present invention. In at least some embodiments, the time to transmit the silencing frame (plus trigger frame, depending upon embodiments) plus time the AP takes to transmit to the STA equals Δt. It should be appreciated that once either parameter—data rate and/or data packet size—has been calculated, it may be stored in memory or a hardware register to be used in future determinations of preferred time for transmission of a silencing frame, including use for comparisons among respective parameter values to ascertain quality of medium, etc.

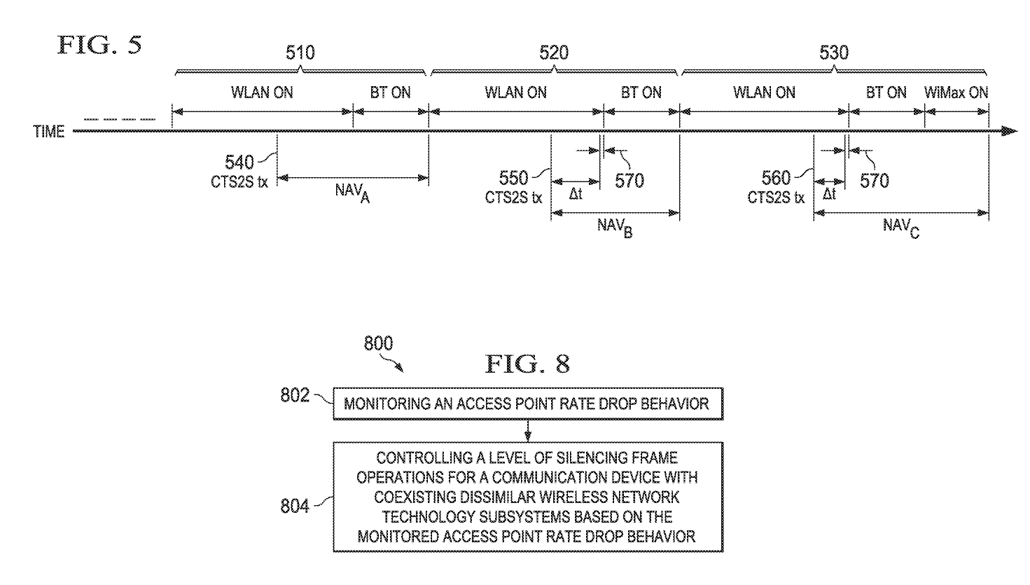

Calculator 440 adds the established transit time(s), i.e., Δt, to the duration of the at least one higher priority interval to be protected to determine a duration (value). In some embodiments, calculator 440 also subtracts the determined duration from the known ending time of the at least one higher priority interval to be protected and identifies the resulting time as the preferred time for transmission of a silencing frame; this preferred time is provided to scheduler 460. In other embodiments, calculator 440 subtracts Δt from the known beginning time of the next immediate at least one higher priority interval to be protected and identifies the resulting time as the preferred time for transmission of a silencing frame; as with other embodiments, this preferred time is provided to scheduler 460. Scheduler 460 directs controller 420 to transmit a silencing frame (e.g., CTS2S frame) at the preferred time. The preferred time occurs Δt prior to the beginning edge of BT active mode (FIG. 5). It should be appreciated that “Δt” will be used to refer to the amount of time (a value) prior to the next immediate higher priority technology network active mode interval during which it is preferred for the device to transmit a silencing frame. As noted above, if controller 420 (via scheduler 460) is unable to transmit a silencing frame during the Δt period of time, then no silencing frame is sent with respect to the next immediate higher priority active mode interval.

Calculator 440 also determines the end time of the predetermined transmission window by subtracting the time it takes to at least completely transmit the silencing frame from the known beginning time of the next immediate at least one higher priority interval to be protected; calculator 440 identifies the resulting time as the ending time of the predetermined transmission window. By so determining the ending time of the transmission window, the scheduler 460 directs controller 420 to complete the transmission of the silencing frame in sufficient time prior to the beginning of the interval(s) to be protected—assuming the medium is not busy. If the medium is busy so that the transmission of the silencing frame cannot be completed prior to the beginning of the interval(s) to be protected (i.e., within the beginning and ending times of the predetermined transmission window), then scheduler 460 directs controller 420 to send no silencing frame, and device/STA 410 transitions to the first of the next immediate at least one higher priority active modes.

It should also be appreciated that a silencing frame cannot be transmitted if the medium is busy (and that if the medium is not busy, the frame is transmitted). However, if the medium is busy, STA will wait until the medium becomes idle again before attempting to transmit the silencing frame. If the medium does not become idle again before the beginning of the next immediate higher priority active mode interval, controller 420 will not send a silencing frame.

On the other hand, if the silencing frame can be transmitted before the start of higher priority (e.g., BT) activity interval, i.e., sometime during the Δt period of time, then the network allocation vector (NAV) or duration is shortened to accommodate the remaining duration of Δt transmission window plus the duration of the at least one higher priority technology network active mode interval (e.g., ending of interval entitled “BT ON” in interval 520 or ending of interval entitled “WiMAX ON” in interval 530, both of FIG. 5). In other words, the value of NAV set at the beginning of Δt transmission window as calculated by calculator 440 is correspondingly reduced by the amount of time the medium remains busy after the maximum preferred frame transmission time has passed. Further, a silencing frame is only transmitted in accordance with the silencing frame control scheme described herein.

During certain intervals, a STA device participates in lower priority technology (WLAN) network, while during other intervals, it participates in higher priority technology networks (BT and WiMAX). In order to avoid the avalanche effect, a silencing frame (e.g., a CTS-to-self frame) is transmitted from the STA. If the silencing frame transmitted is a clear-to-send-to-self frame, it is preferably followed by a trigger frame (which could be a PS-Poll or a quality of service (QoS) Nul frame) indicating to the AP that STA is ready to receive data packets. The silencing frame—in this example, a CTS-to-self frame and subsequent consecutive trigger frame—have the network allocation vector (NAV) set to protect any higher priority technology network (in these examples, BT (interval 520) or BT and WiMAX (interval 530)) active mode period. Thus, the NAV is set to decrement until reaching the zero value at the ending of the higher priority active mode operation duration (which duration may encompass the total duration of more than one higher priority technologies' active modes). All other devices on the particular corresponding technology network, in this example WLAN, defer while their respective NAVs also decrement. Once a deferring device's NAV decrements to zero, the device no longer defers from accessing the medium, or sensing the medium to determine whether the medium is available. Hence, during the time identified in the transmitted silencing frame, no other—in this example—WLAN STA can transmit or receive from the AP. However, as noted above, the time at which a silencing frame is sent impacts the WLAN performance. To improve WLAN throughput, it is preferred that the silencing frame is not sent until Δt time interval before the start of the next immediate higher priority (e.g., BT, WiMAX, etc.) period.

It should be appreciated that what is being referred to herein as a silencing frame may, in some embodiments, comprise more than one transmitted frame, e.g., such as a Clear-to-Send-to-Self frame immediately followed with a trigger frame. In such embodiments, the trigger frame is sent to prevent the other devices on the particular network from assuming that the original Clear-to-Send message was unsuccessful and begin to try to access the medium. However, once the trigger frame follows the Clear-to-Send frame, the other devices on the particular network set their respective NAV to the duration specified in the Clear-to-Send-to-Self frame, and defer until their respective NAV decrements to zero before again attempting to access the medium.

Furthermore, at least some embodiments enable transmission of a silencing frame from STA to take precedence by enabling STA to transmit a silencing frame after point coordination function interframe spacing (PIFS) time interval that the medium is idle. Thus, instead of waiting the customary distributed inter frame space (DIFS) interval before trying to gain access to the medium, it is preferred that the STA waits a PIFS interval before trying to gain access to the medium.

FIG. 5 illustrates an exemplary timing diagram of the operation of an embodiment of STA. In each of exemplary intervals 510, 520 and 530, the STA device completes at least one higher priority network active mode and at least one lower priority network active mode. The timing diagram illustrates the timing of transmission of three silencing frames, under three different scenarios. In interval 510, the silencing frame is randomly transmitted prior to the start of the high priority active mode operation interval; however, in intervals 520 and 530, the silencing frame is transmitted according to embodiments. Specifically, the first frame is sent, without benefit of present embodiments, during interval 510 by STA at a random time at any time during the lower priority active mode interval (WLAN ON, in this example); the second frame is sent, with the benefit of at least one present embodiment, during interval 520 by STA at a preferred time; and the third frame is sent, with benefit of at least one present embodiment, during interval 530 by STA at a respective preferred time. Each preferred time is determined by at least some embodiments as described above. FIG. 5 corresponds to a device STA that alternates among at least two dissimilar network technologies. As noted above, it should be understood that embodiments of the device may switch among more than two dissimilar network technologies. Specifically, there are three exemplary intervals (510, 520, 530) illustrated—each comprising at least one higher priority active mode interval (BT active mode ON and/or WiMAX active mode ON) and one lower priority active mode interval (WLAN active mode ON). In intervals 510 and 520, STA reserves the medium until the end of the BT active mode (ending of interval entitled “BT ON” in FIG. 5) in exemplary interval 520. It should be further understood that although the silencing frame of transmissions 540, 550 and 560 are illustrated to be “CTS2S tx” (clear-to-send-to-self transmission), that other types of silencing frames may be used instead.

Within exemplary interval 510, STA device transmits a silencing frame 540 with duration information for all interested devices to set their NAVs equal to the value of NAV_{A}. It can be seen that there is no Δt in the interval bounded by NAV_{A}. It should be understood that the transmission 540 of a silencing frame occurs randomly at any time within the lower priority technology active mode (e.g., “WLAN ON” in the present example). The time to transmit silencing frame is not predetermined or calculated to be at a specific time. Once it is sent, all interested devices on the respective network set their NAVs to the value corresponding to NAV_{A}. Because the timing of transmission 540 is random at any time within the lower priority technology active mode, transmission 540 regularly—and unnecessarily—ties up network resources which are obliged to defer until their respective NAVs have completely decremented.

Within exemplary interval 520, STA device transmits a silencing frame 550 with duration information for all interested devices to set their NAVs equal to the value of NAV_{B}. However, according to embodiments, the silencing frame may only be sent by the STA during the predetermined transmission window identified in interval 520 by “Δt”. As noted above, Δt transmission window is determined to preferably minimize the amount of time the STA device ties up corresponding technology network resources. The transmission 550 of silencing frame may occur at any time during the predetermined Δt transmission window, depending upon whether the medium is busy, and in some embodiments, whether the STA waits PIFS instead of DIFS after the medium becomes available to transmit. If the medium is not busy, it is preferred that the STA transmit the silencing frame as close to the beginning of the predetermined Δt transmission window as possible. If STA cannot transmit the silencing frame during the Δt transmission window, it will not transmit a silencing frame at all to protect the upcoming higher priority technology active mode (e.g., “BT ON”, in the present illustration).

Within exemplary interval 530, STA device transmits a silencing frame 560 with duration information for all interested devices to set their NAVs equal to the value of NAV_{c}. However, according to embodiments, the silencing frame may only be sent by the STA during the transmission window identified in interval 530 by “Δt”. As with the embodiment of interval 520, Δt transmission window of interval 530 is determined to preferably minimize the amount of time the STA device ties up corresponding technology network resources. The transmission 560 of silencing frame may occur at any time during the Δt transmission window, depending upon whether the medium is busy, and in some embodiments, whether the STA waits PIFS instead of DIFS after the medium becomes available to transmit. If the medium is not busy, it is preferred that the STA transmit the silencing frame as close to the beginning of the predetermined Δt transmission window as possible. If STA cannot transmit the silencing frame during the Δt transmission window, it will not transmit a silencing frame at all to protect the at least one upcoming higher priority technology active mode(s) (e.g., “BT ON” and “WiMAX ON”, in the present illustration).

It should be noticed that the Δt transmission window ends prior to the beginning of the next immediate string of at least one higher priority technology network active modes in intervals 520 (“BT ON”) and 530 (“BT ON and WiMAX ON”), respectively. The silencing frame transmission gap 570 shown in each interval (520,530) illustrates the time it takes to complete transmission of the silencing frame. In some embodiments, gap 570 also includes time for response from another device on the network and/or the time required for the device to switch from one network to the other. It is preferred that the transmission of the silencing frame start during the Δt transmission window. It is further preferred that if the transmission of the silencing frame is started just prior to the end of the Δt transmission window, the transmission of the silencing frame will be completed prior to the commencement of the next immediate (imminent) string of at least one higher priority active modes.

In exemplary interval 530, however, STA reserves the medium until the end of the WiMAX active mode (ending of interval entitled “WiMAX ON” in FIG. 5). Thus, STA device sends a CTS-to-self frame (example of a silencing frame) to protect all consecutive higher priority frames in the next immediate string of higher priority frames. In exemplary interval 530, STA device sends a silencing frame to protect the transmission from STA to AP, the acknowledgement from the AP to STA, the BT ON (active mode interval) and the WiMAX ON (active mode interval). It should also be understood that additional higher priority technology networks may immediately follow the two illustrated in FIG. 5; in such embodiments, STA would send a silencing frame at a preferred time which will protect all such consecutive high priority network activity (active mode intervals). In other words, the duration field of the silencing frame will be set to protect a string of as many consecutive higher priority active modes as needed for a device. Further, it should be noted that the silencing frame transmissions such as those described for FIG. 5 are subject to the silencing frame control scheme described herein.

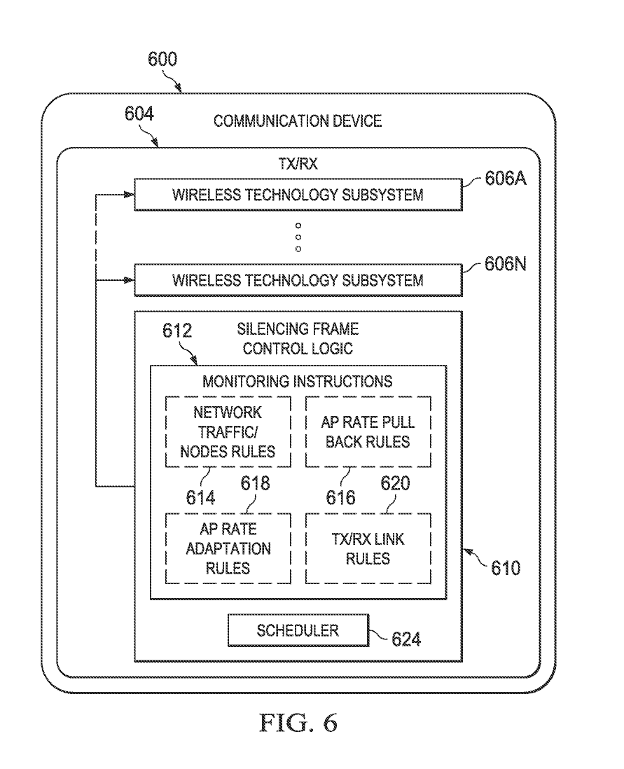

FIG. 6 shows another example of a communication device 600 in accordance with embodiments. The communication device 600 is representative of a STA or communication device with coexisting wireless subsystems as described herein, where a silencing frame control scheme is employed. As shown, the communication device 600 comprises a transceiver (TX/RX) 604 having a plurality of wireless technology subsystems 606A-606N. At least two of the wireless technology subsystems 606A-606N operate at relatively close or overlapping frequency bands with respect to each other such that time-multiplexing is implemented to avoid coexistence interference. Further, the transceiver 604 comprises silencing frame control logic 610 to implement the silencing frame control scheme disclosed herein. The silencing frame control logic 610 enables the transceiver 604 to monitor the rate pull back behavior of an access point (i.e., a drop from a higher rate to a lower rate in response to at least one packet not being received) and to adjust the timing or periodicity of silencing frame operation accordingly. Further, the silencing frame control logic 610 enables the transceiver 604 to monitor the rate adaptation behavior of an access point (e.g., an increase from a lower rate to a higher rate in response to a packet being received) and to adjust the timing or periodicity of silencing frame operation accordingly. For example, the silencing frame control logic 610 may cause the transceiver 604 to increase use of silencing frames in response an observed access point rate drop. Further, the silencing frame control logic 610 may cause the transceiver 604 decrease use of silencing frames in response to an observed access point rate increase. The silencing frame control logic 610 may cause the transceiver 604 to decrease or increase use of silencing frames based on WLAN traffic monitoring, WLAN node detection, internal transmission detection, internal reception detection, or other criteria for a silencing frame control scheme as disclosed herein.

As shown, the silencing frame control logic 610 comprises monitoring instructions 612 and a scheduler 624. More specifically, the monitoring instructions 612 may comprise network traffic/nodes rules 614, AP rate pull back rules 616, AP rate adaptation rules 618, and Tx/Rx link rules 620. In some embodiments, the network traffic/nodes rules 614 cause the transceiver 604 to monitor the number of nodes in a WLAN and/or the amount of traffic. If the number of nodes in a WLAN and/or the amount of traffic is less than a threshold amount as determined by the network traffic/nodes rules 614, the other monitoring operations corresponding to the AP rate pull back rules 616, the AP rate adaptation rules 618, and the Tx/Rx link rules 620 are not performed since silencing frame transmissions are not needed. On the other hand, if the number of nodes in a WLAN and/or the amount of traffic is equal to or greater than a threshold amount as determined by the network traffic/nodes rules 614, at least some of the other monitoring operations corresponding to the AP rate pull back rules 616, the AP rate adaptation rules 618, and the Tx/Rx link rules 620 are performed since silencing frame transmissions may be needed. In other words, the network traffic/nodes rules 614 may determine whether silencing frame transmissions are needed, while the AP rate pull back rules 616, the AP rate adaptation rules 618, and the Tx/Rx link rules 620 determine the amount of silencing frames to be transmitted.

Without limitation to other embodiments, the AP rate pull back rules 616 may notify the scheduler 624 to schedule silencing frames in accordance with the following rules. First, silencing frame (e.g., a CTS-to-self frame) transmissions may be initiated within a predetermined time interval (e.g., 1 second) in order to reach stability in the network. Then, silencing frame transmissions are reduced and monitoring begins. The reduction in the silencing frame transmissions may follow a particular algorithm. For example, if an observed rate index gap parameter is greater than 2, an aggregate rate management (AggrRM) counter parameter is increased. A rate index gap value of 2 between the previous rate and the current rate has been estimated empirically for 802.11g. For other communication protocols, this rate gap could be higher. If AggrRM is greater than a threshold or time gap observed in received packets, then the AP rate pull back rules 616 may direct the scheduler 624 to enter a continuous silencing frame mode. The threshold for AggrRM may be based on the amount of time that these index gaps are observed. This is to avoid some randomness of the network (e.g., packet collisions could cause a rate gap value higher than 2). However, observing too many rate drops within a time period can be a clear indication that the access point is using an aggressive rate drop. Accordingly, the AP rate pull back rules 616 may notify the scheduler 624 to periodically test if reducing silencing frame transmissions is acceptable (i.e., to switch from a continuous silencing frame mode to another scheduling mode). In the case that the scheduler 624 is in the continuous silencing frame mode due to observed aggressive rate drop behavior of the access point, the AP rate pull back rules 616 may cause the silencing frame control logic 610 to periodically check whether the access point still follows the aggressive rate drop behavior.

Additionally or alternatively, the AP rate adaptation rules 618 enable the monitoring instructions 612 to distinguish between AP rate adaptation behavior and AP rate fallback behavior. In the case of rate fallback, having an index gap greater than 2 may be more likely than in the rate adaptation case. Hence, the AP rate adaptation rules 618 may direct the scheduler to switch from a continuous silencing frame mode to a more moderate silencing frame mode if AP rate adaptation is observed (i.e., the AP rate increases from a reduced rate to a higher rate).

Additionally or alternatively, the Tx/Rx link rules 620 may cause the silencing frame control logic 610 to check the Rx link or Tx link associated with the transceiver 604. During transmissions by the Tx link, the access point transmits only transmission control protocol (TCP) acknowledgements (ACKs) to the communicate device 600; hence, the impact of aggressive rate drop is less significant. Accordingly, Tx/Rx link rules 620 may direct the scheduler 624 to reduce the amount of silencing frame transmissions during data transmission operations of the communication device 600 compared to the amount of the amount of silencing frame transmissions during data reception operations of the communication device 600. The scheduler 624 also may operate in accordance with the operations of the controller 420 described for the device/STA of FIG. 4.

To summarize, the silencing frame control logic 610 may cause the communication device 600 to monitor access point rate drop behavior and to adjust a level of silencing frame operations for the communication device 600 based on the monitored access point drop behavior. The silencing frame control logic 610 may cause the communication device to monitor an amount of network traffic or active network nodes, and to initiate monitoring of the access point rate drop behavior in response to the monitored amount of network traffic or active network nodes exceeding a threshold. Further, the silencing frame control logic 610 may cause the communication device 600 to transmit silencing frames within a predetermined time interval to stabilize network traffic before initiating monitoring of the access point rate drop behavior. Further, the silencing frame control logic 610 may cause the communication device 600 to determine whether a change in rate index is greater than a predetermined threshold during monitoring of the access point rate drop behavior. Further, the silencing frame control logic 610 may cause the communication device 600 to increase a rate management count in response to the change in rate index being greater than the predetermined threshold and to cause the communication device 600 to enter a maximum level of silencing frame operations for a predetermined time interval. In some embodiments, the silencing frame control logic 610 may cause the communication device 600 to set the predetermined threshold based on an amount of time that index gaps are observed. Further, the silencing frame control logic 610 may cause the communication device 600 to periodically test silencing frame operations during monitoring of the access point rate drop behavior. Further, the silencing frame control logic 610 may cause the communication device 600 to adjust the level of silencing frame operations downward through multiple levels while monitoring the access point rate drop behavior. Further, the silencing frame control logic 610 may cause the communication device 600 to monitor a transmit link and a receive link of the communication device 600 and to adjust the level of silencing frame operations differently when the monitored transmit link is active compared to when the monitored receive link is active. Further, the silencing frame control logic 610 may cause the communication device 600 distinguish between access point rate adaptation behavior and access point rate fallback behavior, and to adjust the level of silencing frame operations differently for access point rate adaptation behavior and for access point rate fallback behavior.

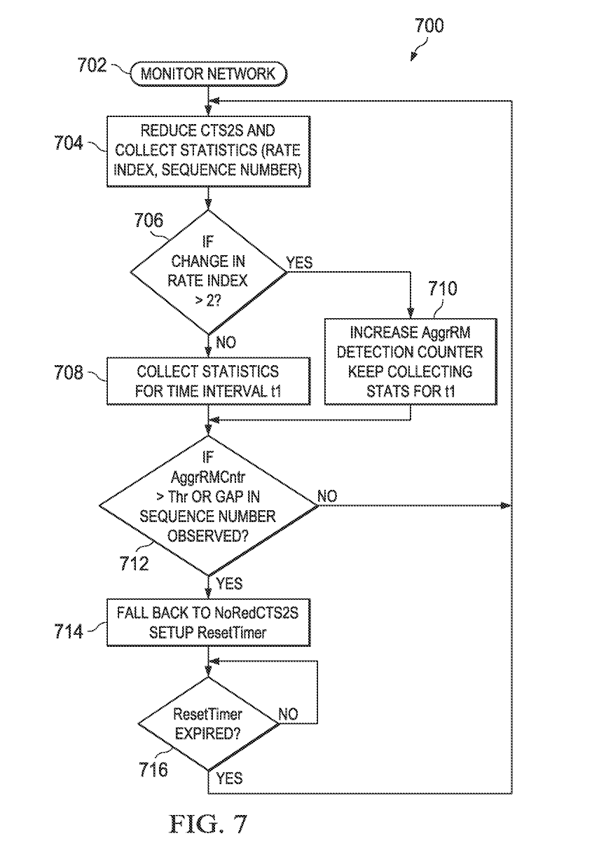

FIG. 7 illustrates a method 700 in accordance with embodiments. The method 700 may be performed by a communication device or station with silencing frame control logic (e.g., silencing frame control logic 610 or controller 420), or by a processor (e.g., processor 320) executing silencing frame control instructions. As shown, method 700 comprises monitoring a network (block 702). At block 704, CTS-to-self transmissions are reduced statistics (e.g., rate index, sequence number) are collected. If the change in rate index is greater than 2 (determination block 706), the AggrRM counter value is increased and statistics are collected during a time period (T1) (block 710). If the change in rate index is not greater than 2 (determination block 706), statistics are still collected during the time interval T1 (block 708). If the AggrRM counter value is greater than a threshold or gap in the observed sequence number (determination block 712), then a continuous silencing frame mode (NoRedCTS2S) is entered and a reset timer is set (block 714). After the timer expires (determination block 716), the method 700 returns to block 704. Also, if the AggrRM counter value is not greater than the threshold or the gap in the observed sequence number (determination block 712), the method 700 returns to block 704.

FIG. 8 illustrates another method 800 in accordance with the disclosure. The method 800 may be performed by a communication device or station with silencing frame control logic (e.g., silencing frame control logic 610 or controller 420) or by a processor (e.g., processor 320) executing silencing frame control instructions. As shown, the method 800 may comprise monitoring access point rate drop behavior (block 802). At block 804, a level of silencing frame operations is controlled for a communication device with coexisting dissimilar wireless network technology subsystems based on the monitored access point rate drop behavior.

In some embodiments, the method 800 may comprise additional or alternative steps. For example, the method 800 may comprise determining a traffic level for a network or a number of active nodes for the network prior to said monitoring, and avoiding steps 802 and 804 if the traffic level or the number of active nodes is less than a threshold amount. Further, the method 800 may comprise performing silencing frame transmissions within a predetermined time interval before initiating step 802. Further, step 804 may comprise matching one of multiple levels of silencing frame operations with an amount of access point rate drop that is observed during step 802. Further, step 804 may comprise performing a highest level of silencing frame operations in response to a predetermined amount of access point rate drop. Further, the method 800 may comprise distinguishing between access point rate adaption behavior and access point rate fallback behavior and controlling the level of silencing frame operations differently for detected access point rate adaption behavior compared to detected access point rate fallback behavior. Further, the method 800 may comprise monitoring a transmit link and a receive link for the communication device, and controlling the level of silencing frame operations differently for detected transmit link activity levels compared to detected receive link activity levels.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communication device, comprising:
a transceiver comprising at least two dissimilar wireless network technology subsystems; and
a silencing frame controller to monitor access point rate drop behavior and to adjust a level of silencing frame operations for the communication device based on the monitored access point drop behavior.

2. The communication device of claim 1, wherein the silencing frame controller monitors an amount of network traffic or active network nodes, and initiates monitoring of the access point rate drop behavior in response to the monitored amount of network traffic or active network nodes exceeding a threshold.

3. The communication device of claim 2, wherein the silencing frame controller transmits silencing frames within a predetermined time interval to stabilize network traffic before initiating said monitoring of the access point rate drop behavior.

4. The communication device of claim 1, wherein the silencing frame controller determines whether a change in rate index is greater than a predetermined threshold during said monitoring of the access point rate drop behavior.

5. The communication device of claim 4, wherein the silencing frame controller increases a rate management count in response to the change in rate index being greater than the predetermined threshold and causes the communication device to enter a maximum level of silencing frame operations for a predetermined time interval.

6. The communication device of claim 4, wherein the silencing frame controller sets the predetermined threshold based on an amount of time that index gaps are observed.

7. The communication device of claim 1, wherein the silencing frame controller causes the communication device to periodically test silencing frame operations during said monitoring of the access point rate drop behavior.

8. The communication device of claim 1, wherein the silencing frame controller causes the communication device to adjust the level of silencing frame operations downward through multiple levels while monitoring the access point rate drop behavior.

9. The communication device of claim 1, wherein the silencing frame controller monitors a transmit link and a receive link of the communication device and adjusts the level of silencing frame operations differently when the monitored transmit link is active compared to when the monitored receive link is active.

10. The communication device of claim 1, wherein the silencing frame controller distinguishes between access point rate adaptation behavior and access point rate fallback behavior, and adjusts the level of silencing frame operations differently for access point rate adaptation behavior and for access point rate fallback behavior.

11. A method, comprising:
monitoring, by a processor, an access point rate drop behavior; and
controlling, by the processor, a level of silencing frame operations for a communication device with coexisting dissimilar wireless network technology subsystems based on the monitored access point rate drop behavior.

12. The method of claim 11, further comprising determining a traffic level for a network or a number of active nodes for the network prior to said monitoring, and avoiding said monitoring and controlling if the traffic level or the number of active nodes is less than a threshold amount.

13. The method of claim 11, further comprising performing silencing frame transmissions within a predetermined time interval before initiating said monitoring of access point rate drop operations.

14. The method of claim 11, wherein controlling the silencing frame operations comprising matching one of multiple levels of silencing frame operations with an amount of access point rate drop that is observed during said monitoring.

15. The method of claim 11, wherein controlling the silencing frame operations comprises performing a highest level of silencing frame operations in response to a predetermined amount of access point rate drop.

16. The method of claim 11, further comprising distinguishing between access point rate adaption behavior and access point rate fallback behavior and controlling the level of silencing frame operations differently for detected access point rate adaption behavior compared to detected access point rate fallback behavior.

17. The method of claim 11, further comprising monitoring a transmit link and a receive link for the communication device, and controlling the level of silencing frame operations differently for detected transmit link activity levels compared to detected receive link activity levels.

18. A system, comprising:
a communication device with coexisting dissimilar wireless network technology subsystems; and
an access point in communication with the communication device,
wherein the communication device employs silencing frame transmission control rules to dynamically adjust a level of silencing frame operations based on a detected rate drop behavior of the access point.

19. The system of claim 18, wherein the silencing frame transmission control rules cause the communication device to dynamically adjust the level of silencing frame operations based on distinguishing between rate pullback operations of the access point and rate adaptation operations of the access point.

20. The system of claim 18, wherein the silencing frame transmission control rules cause the communication device to dynamically adjust the level of silencing frame operations based on monitoring a transmit link and a receive link of the communication device.
